(19) United States
(12) Patent Application Publication
(10) Pub. No.: US 2022/0309574 A1
(43) Pub. Date: Sep. 29, 2022

(54) DYNAMIC INTEREST RATES BASED ON DRIVING SCORES

(71) Applicant: STATE FARM MUTUAL AUTOMOBILE INSURANCE COMPANY, Bloomington, IL (US)

(72) Inventor: Eric Webster, Bloomington, IL (US)

(21) Appl. No.: 15/890,831

(22) Filed: Feb. 7, 2018

Related U.S. Application Data
(60) Provisional application No. 62/509,810, filed on May 23, 2017.

(51) Int. Cl. G06Q 40/02; G07C 5/00; G07C 5/08

(52) U.S. Cl. CPC G06Q 40/025; G07C 5/008; G07C 5/08

(57) ABSTRACT

Techniques are disclosed to recognize and leverage a correlation between improved driving safety and lower financial risk. For drivers identified as being particularly safe, interest rates associated with various installment-based products (e.g., a vehicle loan) may be dynamically adjusted based upon each user's driving habits over time. To identify safe drivers, telematics data (e.g., acceleration, cornering, speed, and braking data) and other information may be collected identifying each user and providing an indication of driving safety, which may be represented as a numeric driving score. Each driver's numeric driving score may be used to identify safe drivers and, once identified, the techniques include adjusting interest rates and/or other installment-based program parameters by an amount that is based upon each driver's particular driving score.

### CROSS REFERENCE TO RELATED APPLICATIONS

This application claims the benefit of U.S. Provisional Patent Application No. 62/509,810, entitled “Dynamic Interest Rates Based on Driving Scores,” filed May 23, 2017, the disclosure of which is hereby expressly incorporated by reference herein in its entirety.

### TECHNICAL FIELD

The present disclosure relates to the dynamic calculation of various parameters related to installment-based programs and, more particularly, to the dynamic calculation of interest rates based upon driving scores.

### BACKGROUND

Traditionally, safer drivers have been offered various discounts and lower insurance premiums. However, the sole association of safe driving with insurance rate discounts may not be a sufficient incentive to change driving behavior. Therefore, existing systems that exclusively rely upon insurance-related discounts to incentivize safer driving may be inadequate and have several drawbacks.

### BRIEF SUMMARY

In one aspect, a computer-implemented method for dynamically adjusting interest rates based upon driving scores may be provided. The method may include one or more processors (and/or associated transceivers) (1) receiving data identifying a set of operators; (2) identifying a set of qualifying operators (i) for which driving scores are available representing a quantified scaled value that indicates a level of driving safety for each respective operator from among the set of operators, and (ii) are enrolled in an installment-based program having an installment amount that is based upon an interest rate; (3) identifying safe operators included in the set of qualifying operators having a respective driving score exceeding a threshold score; and (4) adjusting the interest rate associated with the installment-based program for each safe operator included in the set of qualifying operators based upon the exceeded threshold score. The method may include additional, less, or alternate actions, including those discussed elsewhere herein

In yet another aspect, a computing device for dynamically adjusting interest rates based upon driving scores may be provided. The computing device may include (1) one or more communication units (and/or associated transceivers) configured to receive data identifying a set of operators. The computing device may further include (2) a processing unit configured to (a) identify a set of qualifying operators (i) for which driving scores are available representing a quantified scaled value that indicates a level of driving safety for each respective operator from among the set of operators, and (ii) are enrolled in an installment-based program having an installment amount that is based upon an interest rate, and (b) identify safe operators included in the set of qualifying operators having a respective driving score exceeding a threshold score; and (c) adjust the interest rate associated with the installment-based program for each safe operator included in the set of qualifying operators based upon the exceeded threshold score. The computing device may include additional, less, or alternate components, including those discussed elsewhere herein.

Still further, a non-transitory computer readable medium may be provided having instructions stored thereon that, when executed by one or more processors, cause the one or more processors to: (1) receive data identifying a set of operators; (2) identify a set of qualifying operators (i) for which driving scores are available representing a quantified scaled value that indicates a level of driving safety for each respective operator from among the set of operators, and (ii) are enrolled in an installment-based program having an installment amount that is based upon an interest rate; (3) identify safe operators included in the set of qualifying operators having a respective driving score exceeding a threshold score; and (4) adjust the interest rate associated with the installment-based program for each safe operator included in the set of qualifying operators based upon the exceeded threshold score.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF DRAWINGS

FIG. 1 illustrates a block diagram of an example dynamically adjusting interest rate system 100, in accordance with certain aspects of the present disclosure;

FIG. 2 illustrates a block diagram of an exemplary client device 200, in accordance with certain aspects of the present disclosure;

FIG. 3 illustrates a block diagram of an exemplary interest rate calculation engine 300, in accordance with certain aspects of the present disclosure;

FIG. 4 illustrates exemplary information associated with a user profile 400, in accordance with certain aspects of the present disclosure;

FIG. 5A illustrates an exemplary information 500 collected from various vehicle operators, in accordance with certain aspects of the present disclosure;

FIG. 5B illustrates an example of the identification of qualified vehicle operators using the information 500, in accordance with certain aspects of the present disclosure;

FIG. 5C illustrates an example of various tiers of safe vehicle operators, in accordance with certain aspects of the present disclosure;

FIG. 6 illustrates an exemplary computer-implemented method flow 600, in accordance with certain aspects of the present disclosure.

The Figures depict aspects of the present invention for purposes of illustration only. One skilled in the art will readily recognize from the following discussion that alternate aspects of the structures and methods illustrated herein may be employed without departing from the principles of the invention described herein.

### DETAILED DESCRIPTION

Conventional automobile insurance rates may consider the overall safety of drivers and provide discounts for safe drivers. To identify safe drivers, insurers have provided diagnostic tools that collect information from insured drivers, allowing the insurer to monitor the insurer's driving habits, assess the risk of insuring these drivers, and provide premium pricing accordingly. In some instances, these diagnostic tools are on-board diagnostic (OBD) systems that plug into a vehicle's OBD port, while in other instances insurers utilize mobile applications executed via smartphones located in a vehicle to collect data and transmit the collected data to the insurer. Insurers may then incentivize insured drivers to drive safer, generally by providing safe driving discounts that represent a reduced insurance premium. For some drivers, however, this may not act as a sufficient incentive to change driving behavior.

To remedy this, the present aspects relate to, inter alia, leveraging telematics data to provide additional incentives for insured drivers in the form of temporarily reduced interest rates, which allow drivers to save costs for non-insurance related products. For example, many insurers have third-party affiliates or financial-based branches that provide services such as deposit accounts, auto-financing loans, mortgages, credit cards, home equity loans, etc. Therefore, insurers may advantageously utilize data that is collected regarding driving habits to selectively target safer drivers for other monetary benefits involving a wide array of products.

In particular, studies have shown that fiscally responsible individuals, e.g., those who rarely miss payments or default on loans, tend to drive in a safer manner than less fiscally responsible individuals. Said another way, there is a correlation between an individual's financial risk and the risk associated with insuring the individual. Conventionally, this correlation has been used only in “one direction.” For instance, information such as credit reports may be used to identify the financial risk of a driver, which in turn is used as a condition of approval and insurance coverage pricing. However, certain aspects include exploiting this correlation in the other direction, i.e., by identifying safe drivers with lower financial risks, and rewarding these drivers accordingly to further incentivize safe driving while minimizing the risk of the safe driver defaulting on a particular loan or other installment-based product for which a lower interest rate is offered.

To do so, certain aspects include aggregating data associated with a group of vehicle operators, each of whom may be uniquely identified and may be automotive insurance customers. The term “operator” is used interchangeably herein with other terms relating to vehicle operators throughout his disclosure, such as “drivers” or “users.”

Using various sources of telematics data, a driving score may be calculated for each of these drivers. Moreover, by communication with various databases, third-party servers, and/or other back-end components, qualifying drivers may be identified who have an associated driving score and are enrolled in one or more qualifying installment-based programs. In the various aspects described herein, qualifying installment-based programs may include, for instance, one or more financial products for which one or more parameters (e.g., interest rate) associated with that product may be changed to at least temporarily benefit a driver from within the qualifying drivers who is considered a “safe” driver. Once the safe drivers are identified, the aspects further include segmenting the safe drivers into tiers to recognize various levels of driving safety based upon each safe driver's respective driving score. An interest rate or other parameters associated with various installment programs may then be modified for each individual driver based upon each safe driver's score, such that safer drivers with a higher driving score receive a larger interest rate reduction than safe drivers with lower driving scores. In this way, driving safety may be monitored for several drivers over time, and a measure of each driver's safety may be utilized to dynamically adjust one or more parameters of various products in which the driver is enrolled.

System Overview

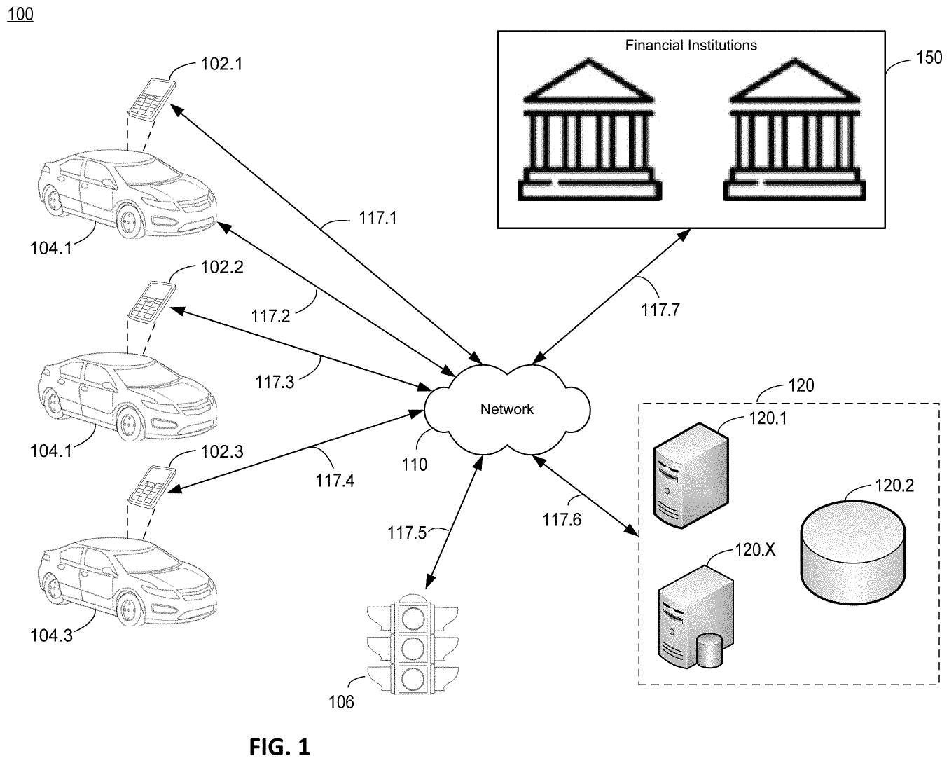

FIG. 1 illustrates a block diagram of an exemplary dynamically adjusting interest rate system 100 (“system 100”), in accordance with certain aspects of the present disclosure. In various aspects, the system 100 may include one or more client devices 102.1-102.3 and respective vehicles 104.1-104.3, one or more smart infrastructure components 106, one or more communication networks 110, one or more financial institutions 150, and any suitable number X of back-end computing devices 120, which may include back-end computing devices 120.1-120.X, for example.

Although FIG. 1 illustrates three client devices 102.1-102.3, three vehicles 104.1-104.3, one smart infrastructure component 106, one communication network 110, two financial institutions 150, and three back-end computing devices 120, it is to be understood that system 100 may include any suitable number of such components. Moreover, system 100 may include additional, less, or alternate components, including those discussed elsewhere herein. For example, back-end computing devices 120 may include several hundred components, including a server configured to communicate with several hundred or several thousand client devices 102 and/or vehicles 104, each of which may be operated by a separate user or operator.

Furthermore, the various communication links shown in FIG. 1 are shown for ease of explanation, and it will be understood that each of the components implemented via system 100 may be configured to communicate with one another directly and/or indirectly. For example, to facilitate indirect communications, communication network 110 may be configured to facilitate communications between one or more client devices 102.1-102.3, one or more vehicles 104.1-104.3, one or more smart infrastructure components 106, one or more financial institutions 150, and/or one or more back-end computing devices 120 using any suitable number of wired and/or wireless links, which may be represented as links 117.1-117.7, for example. For instance, communication network 110 may represent any suitable number of nodes, radio frequency links, wireless or digital communication channels (each of which may be capable of wireless data transmission), additional wired and/or wireless networks that may facilitate one or more landline connections, internet service provider (ISP) backbone connections, satellite links, public switched telephone network (PSTN), etc. To provide additional examples, the present aspects include communication network 110 being implemented, for example, as a local area network (LAN), a metropolitan area network (MAN), a wide area network (WAN), or any suitable combination of local and/or external network connections. To provide further examples, communications network 110 may include wired telephone and cable hardware, satellite, cellular phone communication networks, base stations, macrocells, femtocells, etc.

In various aspects, each of client devices 102.1-102.3 may be implemented as any suitable type of device, which may be integrated as part of the vehicle 104 in which it is located or as a portable device separate from the vehicle. For example, the client devices 102.1-102.3 may be implemented as mobile computing devices, such as smartphones, or as integrated components, such as on-board vehicle computers. The vehicles 104.1-104.3 may be human operated, or autonomous or semi-autonomous vehicles, in some embodiments. It should be appreciated that other types of electronic devices and/or mobile devices are envisioned, such as notebook computers, tablets, phablets, GNSS-enabled devices, smart watches, smart glasses, smart bracelets, wearable electronics, PDAs (personal digital assistants), pagers, computing devices configured for wireless communication, etc.

In the present aspects, smart infrastructure component 106 may be implemented as any suitable type of traffic infrastructure component configured to receive communications from and/or to send communications to other devices, such as one or more client devices 102.1-102.3, one or more vehicles 104.1-104.3, and/or one or more back-end computing devices 120.1-120.X, for example. In various aspects, smart infrastructure component 106 may be implemented as a traffic light, a railroad crossing light, a construction notification sign, a roadside display configured to present messages, a billboard display, a toll booth, exit ramp, overpass, bridge, etc.

In the present aspects, one or more of client devices 102.1-102.3, one or more of the vehicles 104.1-104.3, and/or one or more infrastructure components 106 may be configured to measure, generate, collect, store, and/or transmit what is referred to herein as “telematics data.” In some instances, this telematics data may be transmitted while one or more of vehicles 104.1-104.3 is being driven. This telematics data may be transmitted, for example, to one or more back-end components 120 to facilitate the calculation of a driving score for each vehicle's respective driver. The telematics data may be generated, for example, via one or more sensors integrated as part of, or otherwise associated with, one or more of client devices 102.1-102.3, one or more of the vehicles 104.1-104.3, and/or one or more infrastructure components 106.

As used herein, the term “telematics data” may refer to any suitable type of information that is indicative of driving behavior, driving safety, and/or driving conditions. In various aspects, the telematics data may be used, for example, to identify a particular client device, a particular driver or vehicle, a particular smart infrastructure component, driving behavior or habits, road conditions, vehicle locations, operators, a vehicle's movement while being driven, etc., regardless of the particular component or source that generates the telematics data.

For example, telematics data may include various sensor metrics and/or geographic location data generated by one or more sensors or other suitable components. For instance, the telematics data may include, regardless of the device generating it, sensor metrics or other information indicating changes in a vehicle's acceleration, braking, cornering, and/or velocity over time, which may include a timestamp associated with the sampled telematics data to allow each sampled data point to be associated with a specific time, thereby facilitating tracking changes in the telematics data over time. To provide yet another example, the telematics data may include information related to accelerometer sensor measurements, gyroscope sensor measurements, compass heading measurements, etc. To provide further examples, the telematics data may include information indicative of changes in the geographic location of a particular client device 102.1-102.3 and/or vehicle 104.1-104.3, which may likewise be correlated to a time stamp to identify the movement of a vehicle over time, and thus track its velocity and/or route.

Still further, the telematics data may include information indicative of a usage of a device (e.g., a log indicating when the user was texting or talking on a client device 102 while driving), and/or a battery level associated with client device 102. The telematics data may also include data identifying certain weather conditions, which may be measured by a particular device or retrieved from a separate data source via data communications by that device and included in a telematics data transmission. This list is not meant to be exhaustive or limiting, and it will be understood that other types of information may be included in the telematics data transmission not listed here in accordance with the aspects described herein without departing from the spirit and scope of the present disclosure.

One or more financial institutions 150 may include any suitable number and/or type of financial institutions that hold and/or are associated with various financial accounts and/or installment-based programs. For example, one or more financial institutions 150 may include banks, creditors, lenders, and/or brokers. One or more users (e.g., an insured customer and/or user associated with one of client devices 102.1-102.3) may hold one or more accounts with one or more financial institutions 150 such as deposit accounts (e.g., checking accounts, savings accounts, money market accounts, etc.), credit accounts (e.g., credit card accounts, charge accounts, lines of credit, etc.), loan accounts, (e.g., mortgage accounts, auto financing loans, home equity loans, etc.), brokerage accounts, etc. These accounts may be held at a single institution or spread out across several different financial institutions.

In the present aspect, financial accounts held at one or more financial institutions 150 may be accessible via a secure connection to communication network 110, for example, by one or more client devices 102.1-102.3 and/or one or more back-end computing devices 120.1-120.X. For example, one or more financial institutions 150 may provide online services that allow a user to access her accounts using a client device 102.1-102.3 and/or another suitable computing device. Upon receipt of a valid authenticated request for financial data, one or more financial institutions 150 may transmit financial data to a client device 102.1-102.3 and/or one or more back-end computing devices 120. Examples of the financial data transmitted by one or more financial institutions 150 may include financial transaction data indicating previous credits and debits to a user's accounts, a current account balance, various parameters associated with one or more installment-based products such as the amount, term, amortization schedule, and/or interest rate associated with one or more loans, loan payoff balances, credit report history, credit scores, credit card utilization, derogatory credit marks, spending data such as the time, amount, and specific merchant for which previous account debits and/or charges were made, whether the user has previously defaulted on a particular loan, etc.

In various aspects, back-end computing devices 120 may include any suitable number of back-end components, which may include any suitable type of components configured to receive, send, store, and/or analyze data to facilitate the performance of the functions of the various embodiments as described herein. For example, as shown in FIG. 1, back-end computing devices 120 may include one or more interest rate calculation engines 120.1, one or more databases 120.2, and/or one or more database servers 120.X.

In various aspects, interest rate calculation engine 120.1 may be implemented as any suitable number and/or type of computing device (e.g., one or more computer servers) configured to communicate with other various components such as other back-end components 120.2-120.X, one or more client devices 102.1-102.3, one or more vehicles 104.1-104.3, one or more smart infrastructure components 106, and/or one or financial institutions 150. In the present aspects, interest rate calculation engine 120.1 may be configured to access data from and/or store data to one or more additional data sources that may be included as one or more of back-end computing devices 120. These data sources may provide data that is utilized by interest rate calculation engine 120.1 for various purposes.

For example, interest rate calculation engine 120.1 may use this data to aggregate telematics data, driving scores, and/or other information from several operators (e.g., operators associated with one or more client devices 102.1-102.3), each of whom may be an automotive insurance customer and associated with a particular insured vehicle (e.g., vehicles 104.1-104.3), to identify qualifying operators, to segment safe operators from within the qualifying operators into various safety tiers based upon their driving scores, and to adjust an interest rate for one or more safe operators based upon their driving score and/or tier. Additionally, interest rate calculation engine 120.1 may be configured to communicate with one or more financial institutions and/or other suitable components included in one or more back-end components 120 to effectuate the adjusted interest rate for each operator. To provide additional examples, interest rate calculation engine 120.1 may additionally or alternatively be configured to support one or more applications installed on one or more client devices 102.1-102.3.

Moreover, the aspects described herein allocate the calculations and functionality for dynamically adjusting an interest rate with interest rate calculation engine 120.1 for ease of explanation. However, certain aspects include interest rate calculation engine 120.1 working in conjunction with any suitable number of other components of system 100 to facilitate the functionality associated with the aspects of the disclosure as described herein. For example, interest rate calculation engine 120.1 may work in conjunction with other servers, databases, cloud-based servers, etc., included as part of the one or more back-end computing devices 120. To provide another example, interest rate calculation engine 120.1 may work in conjunction with one or more client devices 102.1-102.3. Additionally or alternatively, one or more functions described herein with respect to interest rate calculation engine 120.1 may also be performed via one or more client devices 102.1-102.3 or financial institutions 150, which similarly may work in conjunction with work one or more of back-end computing devices 120.

Database 102.2 may include one or more storage devices configured to store, delete, update, and/or modify data in accordance with one or more commands received from one or more other back-end components 120, one or more client devices 102.1-102.3, and/or one or more financial institutions 150. For example, database 120.2 may include any suitable combination of one or more storage mediums such as hard disk drives, solid state memory, cloud-based storage devices, etc. In various aspects, database 120.2 may store data in addition to or instead of data stored locally by interest rate calculation engine 120.1. In doing so, interest rate calculation engine 120.1, database 120.2, and/or other back-end components 120 may store any suitable type of data used to facilitate the various functionalities of the aspects as described herein.

Examples of the data stored among the various components of one or more back-end components 120 include data identifying the operators of one or more vehicles (e.g., vehicles 104.1-104.3), the user profiles associated with various operators, telematics data, and/or driving scores. To provide additional examples the data stored among the various components of one or more back-end components 120 may include financial information for various operators such as information regarding qualifying installment-based programs (e.g., a listing of names, various parameters, etc.). As additional examples, the data stored among the various components of one or more back-end components 120 may include a particular tier or segment to which each operator currently belongs, executable code, algorithms, instructions, etc., used to perform functions associated with the various aspects as discussed herein, etc. Moreover, data stored in database 120.2 (and/or one or more other back-end components 120) may be accessed via one or more client devices 102.1-102.3 and/or the one or more financial institutions 150 as needed.

In some aspects, data stored in database 120.2 (and/or one or more other back-end components 120) may include private or confidential information such as financial records, credit report information, loan information, insurance-related information, etc. Thus, certain aspects include utilizing secure data storage and access procedures when data is written to or retrieved from database 120.2 (and/or one or more other back-end components 120) via interest rate calculation engine 120.1. These procedures may include, for example, secure login and authentication procedures and/or the encryption of data stored in database 120.2 (and/or one or more other back-end components 120).

Database server 120.X may be configured as any suitable number and/or type of server, and may be configured to perform substantially similar functions as interest rate calculation engine 120.1. In some embodiments, interest rate calculation engine 120.1 and database server 120.X may be implemented as a single device, and thus both interest rate calculation engine 120.1 and database server 120.X may not be present in some aspects. But in other aspects, database server 120.X may perform dedicated database operations, while interest rate calculation engine 120.1 performs communication and analytical-based functions.

For example, interest rate calculation engine 120.1 may handle communications with one or more client computing devices 102.1-102.3, one or more vehicles 104.1-104.3, one or more smart infrastructure components 106, one or more financial institutions 150, and/or one or more other back-end components 120. Continuing this example, interest rate calculation engine 120.1 may perform calculations related to identifying qualifying drivers, identifying safe drivers from among the qualifying drivers, and adjusting interest rates for identified safe drivers. Further continuing this example, in such a case, database server 120.X may facilitate the receipt of information and the aggregation of data from various sources. For example, as new information is received for a particular driver over time, database server 120.X (or other back-end components 120 such as interest rate calculation engine 120.1) may append, substitute, update, or otherwise modify the information for each operator so that it remains up-to-date.

To provide another example, database 120.2 (and/or one or more other back-end components 120) may store user information, logon credentials, and contact information for one or more users. Interest rate calculation engine 120.1 may access data stored in database 120.2 (and/or one or more other back-end components 120) to correlate data received from various data sources to a particular operator for data aggregation and/or to facilitate the transmission of instructions to facilitate adjusting that operator's interest rate (or other parameters as discussed herein).

An Exemplary Client Device

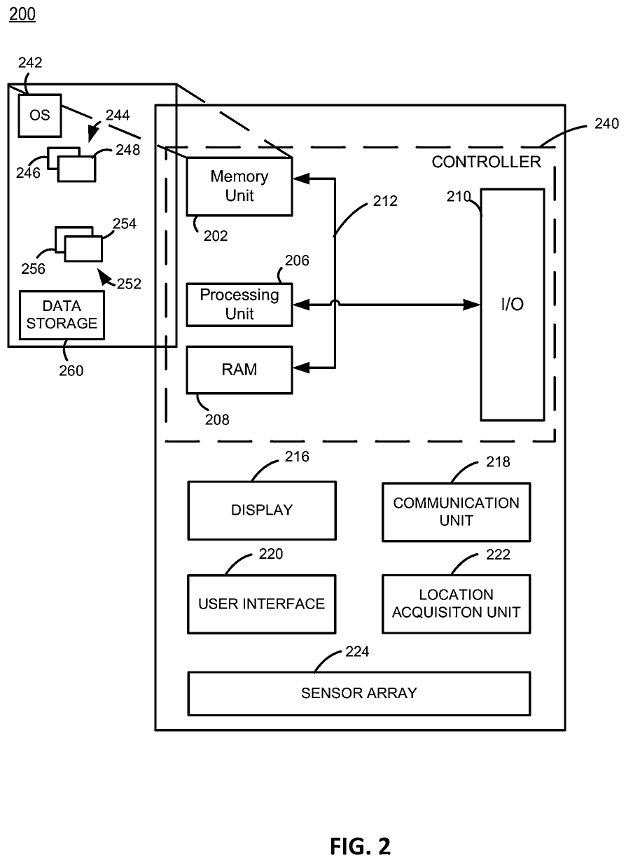

FIG. 2 illustrates a block diagram of an exemplary client device 200, in accordance with certain aspects of the present disclosure. In the present aspects, client device 200 may be an implementation of one of client devices 102.1-102.3, as discussed herein with reference to FIG. 1. In various aspects, client device 200 may include a controller 240 having various components associated therewith such as, for example a memory unit 202, a processing unit 206, a RAM 208, and an I/O block 210. Client device 200 may further include a display 216, a communication unit 218, a user interface 220, a location acquisition unit 222, and a sensor array 224. Client device 200 may include additional, less, or alternate components, including those discussed elsewhere herein.

In various aspects, client device 200 may be implemented as any suitable computing device configured to receive user input, display information, and/or communicate with other components, such as those described herein with reference to client devices 102.1-102.3 of system 100, for example. For instance, client device 200 may be implemented as a smartphone or other suitable mobile computing device.

Client device 200 may be configured to communicate using any suitable number and/or type of communication protocols, such as Wi-Fi, cellular, BLUETOOTH, NFC, RFID, Internet Protocols, etc. For example, client device 200 may be configured to communicate with various communication networks using a cellular communication protocol to send data to and/or receive data from these components. To this end, communication unit 218 may be configured to facilitate data communications between client device 200 and one or more components such as one or more financial institutions (e.g., one or more financial institutions 150), one or more back-end computing devices (e.g., one or more back-end computing devices 120), one or more other client devices (e.g., one or more client devices 102.1-102.3), one or more vehicles (e.g., one or more client vehicles 104.1-104.3), one or more smart infrastructure components (e.g., smart infrastructure component 106), one or more networks (e.g., network 110), etc., in accordance with any suitable number and/or type of communication protocols.

Such communications may facilitate the transmission of collected data from client device 200 (e.g., telematics data), which may be utilized by various back-end components (e.g., interest rate calculation engine 120.1) as further discussed herein. In the present aspects, communication unit 218 may be implemented with any suitable combination of hardware and/or software to facilitate this functionality. For example, communication unit 218 may be implemented with any suitable number of wired and/or wireless transceivers, network interfaces, physical layers (PHY), ports, antennas, etc.

Moreover, communication unit 218 may be further configured to receive data from one or more back-end components (e.g., interest rate calculation engine 120.1) as further discussed herein. In response to receiving this data, client device 200 may provide various notifications, prompts, or other suitable information to the user and/or request additional feedback from the user. For instance, client device 200 may provide information related to the user's enrolled installment programs, current and adjusted interest rates, driving scores, the user's present safety tier among other drivers based upon her driving score, etc. To this end, user interface 220 may be configured to facilitate user interaction with client device 200. For example, user interface 200 may include a user-input device such as an interactive portion of display 216 (e.g., a “soft” keyboard displayed on display 216), an external hardware keyboard configured to communicate with client device 200 via a wired or a wireless connection (e.g., a BLUETOOTH keyboard), an external mouse, or any other suitable user-input device.

Furthermore, display 216 may be implemented as any suitable type of display that may facilitate user interaction, such as a capacitive touch screen display, a resistive touch screen display, etc. In various aspects, display 216 may be configured to work in conjunction with user-interface 220 and/or controller 240 to detect user inputs upon a user selecting a displayed interactive icon or other graphic, to identify user selections of objects presented via display 216, to display the aforementioned information, etc.

Location acquisition unit 222 may be configured to generate geographic location data utilizing any suitable global positioning techniques. For example, location acquisition unit 222 may communicate with one or more satellites and/or wireless transmitters to determine a location of client device 200. Location acquisition unit 222 may use “Assisted Global Positioning System” (A-GPS), satellite GPS, or any other suitable global positioning protocol (e.g., the GLONASS system operated by the Russian government, the Galileo system operated by the European Union, etc.) to determine a geographic location of client device 200.

In the present aspects, location acquisition unit 222 may periodically store one or more geographic locations of client device 200 as geographic location data in any suitable portion of memory utilized by client device 200 (e.g., memory unit 202, RAM 208, etc.) and/or to another device (e.g., an external computing device, etc.). Moreover, location acquisition unit 222 may sample the location of client device 200 in accordance with any suitable sampling rate (e.g., every 5 seconds, 10 seconds, 30 seconds, etc.), store this geographic location data representing the position of client device 200, and thus the vehicle in which it is travelling, over time. Further in accordance with the present aspects, the geographic location data may be part of the telematics data discussed herein, and may be included as part of a telematics data transmission that is subsequently received, stored, and analyzed by one or more back-end components (e.g., interest rate calculation engine 120.1), as further discussed herein.

The client device 200 may further include a sensor array 224. In various aspects, the controller 240 and its associated components and applications may be configured to interface with the sensor array 224 to retrieve and process the corresponding sensor data. To facilitate this functionality, the sensor array 224 may include one or more sensors configured to collect various types of sensor data, such as acceleration and/or velocity data, for example. For example, the sensor array 224 may include one or more cameras, accelerometers, gyroscopes, velocity sensors, magnetometers, barometers, thermometers, proximity sensors, light sensors, Hall Effect sensors, etc. In certain aspects in which the sensor array 224 includes one or more accelerometers, the sensor array 224 may be configured to measure and/or collect accelerometer values utilizing an X-axis, Y-axis, and Z-axis accelerometer. In accordance with such aspects, the sensor array 224 may measure sensor metric values as a three-dimensional accelerometer vector that represents the movement of the client device 200 in three-dimensional space by combining the outputs of the X-axis, Y-axis, and Z-axis accelerometers using any suitable techniques.

In one aspect, the accelerometer movement may then be analyzed (e.g., either locally via client device 200 or via a back-end component such as interest rate calculation engine 120.1) to determine the movement of the client device 200, and thus the movement of the vehicle in which the client device 200 is located. In any event, the sensor array 224 may facilitate measuring the movement of the client device 200 over time in accordance with any suitable sampling period, such as continuously or periodically, for example. Thus, the telematics data transmitted via the client device 200 may include an indication of a tracked movement (e.g., acceleration and/or velocity of the vehicle in one or more directions) and the tracked direction of the vehicle in which the client device 200 is located.

Controller 240 may include a memory unit 202, a processing unit 206, a RAM 208, and/or an input/output (I/O) interface 210, each of which may be interconnected via an address/data bus 212. Controller 240 (and/or processing unit 206) may be implemented as any suitable type and/or number of processors, such as a host processor for the relevant device in which client device 200 is implemented, for example.

In accordance with various aspects, memory unit 202 may be a computer-readable non-transitory storage device, and may include any suitable combination of volatile (e.g., a random access memory (RAM)), or non-volatile memory (e.g., battery-backed RAM, FLASH, etc.). In the present aspects, memory unit 202 may be configured to store instructions executable by processing unit 206 and/or controller 240. These instructions may include machine readable instructions that, when executed by processing unit 206 and/or controller 240, cause processing unit 206 and/or controller 240 (and thus client device 200) to perform various acts. To do so, controller 240 and/or processing unit 206 may be configured to communicate with other components of controller 240 and/or other components of client device 200 such as, for example, display 216, communication unit 218, user interface 220, location acquisition unit 222, and/or sensor array 224 to send data to and/or to receive data from one or more of these components.

In the present aspects, processing unit 206 may be configured to communicate with memory unit 202 to store data to and/or to read data from memory unit 202. Furthermore, memory unit 202 may include an operating system (OS) 242, one or more telematics applications 244, and/or other locally executed applications 252 (“applications”). In one embodiment, the applications 244 and/or 252 may include one or more software applications or sets of computer-executable instructions that are stored on the memory unit 202 and executable by the controller 240 and/or processing unit 206. For example, memory unit 202 may represent a tangible, non-transitory computer-readable medium, with each of the applications 244 and 252 including instructions executable by one or more processors (e.g., controller 240 and/or processing unit 206) that, when executed by the one or more processors, cause the one or more processors to perform various acts as described herein. To provide another example, the applications 244 and/or 252 may be implemented at least partially in firmware and/or in hardware at the client device 200.

In some aspects, the applications 244 and/or 252 may reside in memory unit 202 as a default application bundle that may be included as part of the operating system (OS) 242 utilized by client device 200. But in other aspects, the applications 244 and/or 252 may be installed on client device 200 as one or more downloads, such as an executable package installation file downloaded from a suitable application source via a connection to the Internet or other suitable device, network, external memory storage device, etc.

For example, the applications 244 and/or 252 may be stored in any suitable portions of memory unit 202 upon installation of a package file downloaded in such a manner. Examples of package download files may include downloads via the iTunes store, the Google Play Store, the Windows Phone Store, a package installation file downloaded from another computing device, etc. Once downloaded, the applications 244 and/or 252 may be installed on client device 200 as part of an installation package such that, upon installation of the applications 244 and/or 252, memory unit 202 may store executable instructions such that, when executed by controller 240 and/or processing unit 206, cause client device 200 to implement the various functions of the aspects as described herein.

For example, telematics data applications 244 may include a telematics data collection application 246 and a telematics data reporting application 248. In accordance with such aspects, the telematics data collection application 246 may interface with one or more components of client device 200 to collect, measure, and store the data described herein as telematics data.

The telematics data reporting application 248 may, in some aspects, interface with various components of client device 200 (e.g., communication unit 218) to cause client device 200 to transmit the collected and stored telematics data. This transmission may occur, for example, in accordance with any suitable periodic schedule, continuously, each time a threshold movement or distance is detected, etc. Again, this telematics data may be received by one or more back-end components and used for various purposes, such as calculating a driving score, for example.

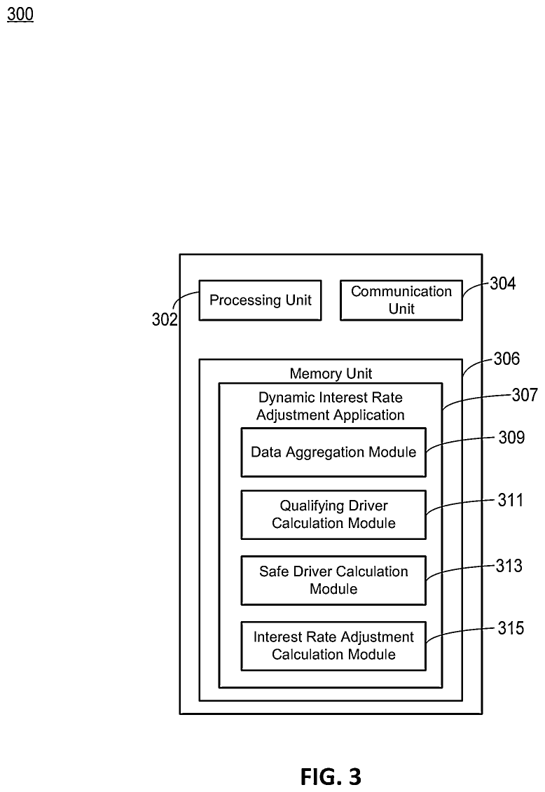

To provide another example, locally executed applications 252 may include a driving score application 254 and a dynamically adjusted interest rate application 256. In some aspects, client device 200 may additionally or alternatively calculate, store, and/or transmit the driving score instead of the driving score being calculated by the one or more back-end components. To this end, the driving score application 254 may include any suitable type of instructions to facilitate client device 200 calculating a driving score based upon any suitable combination of telematics data and/or data received via other sources. The details of calculating a driving score are further discussed below with reference to FIG. 3, with the driving score being calculated by one or more back-end computing devices.

Moreover, aspects include the dynamically adjusted interest rate application 256 working in conjunction with other components of client device 200 (e.g., display 216) to present relevant information to a user. This may include, for instance, data regarding changes to interest rates or installment payments, as further discussed herein.

To provide another example, the dynamically adjusted interest rate application 256 may function to collect information that is used to enroll, establish, or otherwise identify a user to take advantage of the dynamic interest rate adjustments as described herein. For example, the dynamically adjusted interest rate application 256 may work in conjunction with user interface 220 to display various prompts and otherwise allow a user to enter information, which may then be transmitted to one or more back-end components, as discussed herein, to generate a user profile. In certain aspects, via the use of the dynamically adjusted interest rate application 256 (or other suitable component(s) of client device 200), a user may begin the process of creating a user profile or modifying a pre-existing user profile. This may be implemented, for example, upon a user first executing the dynamically adjusted interest rate application 256, through a registration process via a website, via direct or indirect communication with one or more back-end components (e.g., interest rate calculation engine 120.1, which may also be in the form of Internet communications or via interaction with various supported websites), over the phone, etc.

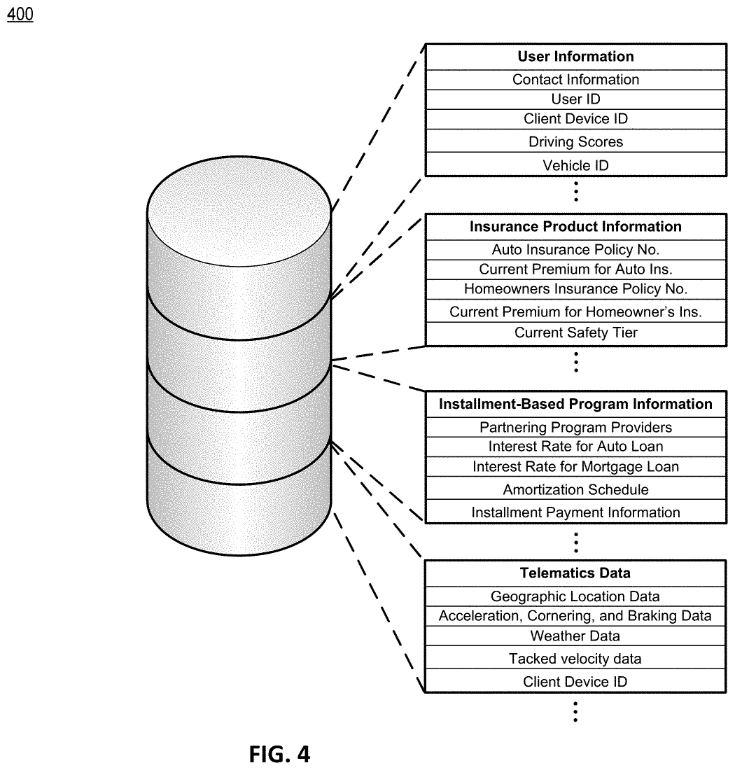

This user profile may therefore initially include, for example, any suitable type of relevant information that is used to identify qualifying drivers, safe drivers, and otherwise calculate various updated parameters associated with one or more installment-based programs based upon how safe a user drives. For example, the user profile may include data that is aggregated from various sources such as user information, insurance provider information, installment-based program information, a history of collected telematics data, etc. To provide additional examples, the user profile may include device information, contact information, a user ID, any qualifying installment-based programs that the user is enrolled, current installment-based program interest rates, one or more insurance products that the user may have, and/or any other suitable type of information that may allow a subsequent correlation of a particular user to other information included in his user profile (e.g., via interest rate calculation engine 120.1). The aggregated data that forms part of a user's profile is further discussed below with reference to FIGS. 3 and 4.

An Exemplary Interest Rate Calculation Engine

FIG. 3 illustrates a block diagram of an exemplary interest rate calculation engine 300, in accordance with certain aspects of the present disclosure. In one aspect, interest rate calculation engine 300 may be an implementation of interest rate calculation engine 120.1, as shown and discussed with respect to FIG. 1. In the present aspects, interest rate calculation engine 300 may include a processing unit 302, a communication unit 304, and a memory unit 306. Interest rate calculation engine 300 may include additional, less, or alternate components, including those discussed elsewhere herein.

It should be noted that, although only a single interest rate calculation engine 300 is shown in FIG. 3, this is only one of many aspects. In some aspects, multiple computing devices, servers, etc., may be configured to have a logical presence of a single entity, such as a server bank or an arrangement known as “cloud computing,” for example. These configurations may provide various advantages, such as enabling near real-time uploads and downloads of information as well as periodic uploads and downloads of information. However, for ease of explanation and not limitation, the interest rate calculation engine 300 is referred to herein using the singular tense. Moreover, although named an “interest rate” calculation engine, aspects include interest rate calculation engine 300 calculating and/or adjusting other parameters associated with various installment-based products, as discussed further herein.

Interest rate calculation engine 300 may be configured to communicate using any suitable number and/or type of communication protocols, such as Wi-Fi, cellular, BLUETOOTH, NFC, RFID, Internet Protocols, etc. For example, the interest rate calculation engine 300 may be configured to communicate with one or more communication networks (e.g., communication network 110) using a cellular communication protocol to send data to and/or receive data from one or more financial institutions (e.g., one or more financial institutions 150), one or more back-end computing devices (e.g., one or more back-end computing devices 120), one or more client devices (e.g., one or more client devices 102.1-102.3), one or more vehicles (e.g., one or more client vehicles 104.1-104.3), one or more smart infrastructure components (e.g., smart infrastructure component 106), etc., via such communications.

To this end, communication unit 304 may be configured to facilitate data communications between various components in accordance with any suitable number and/or type of communication protocols. In the present aspects, communication unit 304 may be configured to facilitate data communications based upon the particular component and/or network with which interest rate calculation engine 300 is communicating.

Again, these communications may facilitate receiving various types of data from various components that may be used, for example, to generate a user profile that is an aggregation of collected information. Moreover, these communications may facilitate transmitting data and/or instructions to various components to effectuate various responses and/or changes from these components, as further discussed herein. In the present aspects, communication unit 304 may be implemented with any suitable combination of hardware and/or software to facilitate this functionality. For example, communication unit 304 may be implemented with any suitable number of wired and/or wireless transceivers, network interfaces, physical layers (PHY), ports, antennas, etc.

Processing unit 302 may be implemented as any suitable type and/or number of processors, such as a host processor for the relevant device in which interest rate calculation engine 300 is implemented, for example. Processing unit 302 may be configured to communicate with one or more of communication unit 304 and/or memory unit 306 to send data to, and/or to receive data from, one or more of these components.

For example, processing unit 302 may be configured to communicate with memory unit 306 to store data to and/or to read data from memory unit 306. In accordance with various embodiments, memory unit 306 may be a computer-readable non-transitory storage device, and may include any combination of volatile (e.g., a random access memory (RAM)), or a non-volatile memory (e.g., battery-backed RAM, FLASH, etc.). In the present aspects, memory unit 306 may be configured to store instructions executable by processing unit 302. These instructions may include machine readable instructions that, when executed by processing unit 302, cause processing unit 302 (and thus the interest rate calculation engine 300) to perform various acts.

In the present aspects, dynamic interest rate adjustment application 307 may be a portion of memory unit 306 configured to store instructions, that when executed by processing unit 302, cause processing unit 302 (and thus the interest rate calculation engine 300) to perform various acts in accordance with applicable aspects as described herein. For example, instructions stored in dynamic interest rate adjustment application 307 may facilitate processing unit 302 executing the various functions described below with respect to each of the modules stored in memory unit 306. Some of these functions may include, for example, receiving, collecting, and/or aggregating various types of data to generate user profiles, identifying qualifying operators who are eligible for dynamic interest rate adjustments, communicating with one or more other devices, components, and/or institutions (e.g., third party loan providers, insurers, financial institutions, etc.), communicating with one or more back-end computing devices, calculating tiers of safe drivers, calculating interest rates associated with various installment-based programs for different users, calculating driving scores, determining user's financial risk tiers, etc. These functions are further discussed below with respect to the each of the additional modules stored in memory unit 306.

Thus, certain aspects include dynamic interest rate adjustment application 307, data aggregation module 309, qualifying driver calculation module 311, safe driver calculation module 313, and interest rate adjustment calculation module 315 being implemented as one or more software applications, sets of computer-executable instructions, algorithms, etc., which are stored on the memory unit 306 and executable by the processing unit 320. For example, memory unit 306 may represent a tangible, non-transitory computer-readable medium, with each of dynamic interest rate adjustment application 307, data aggregation module 309, qualifying driver calculation module 311, safe driver calculation module 313, and interest rate adjustment calculation module 315 including instructions executable by one or more processors (e.g., processing unit 302) that, when executed by the one or more processors, cause the one or more processors to perform various acts as described herein. To provide another example, the dynamic interest rate adjustment application 307, data aggregation module 309, qualifying driver calculation module 311, safe driver calculation module 313, and interest rate adjustment calculation module 315 may be implemented at least partially in firmware and/or in hardware of the interest rate calculation engine 300.

The various applications and modules shown in FIG. 3 and discussed herein may be executed on the same processing unit 302 or on different computer processors (which may also be part of separate components not pictured in FIG. 3) in some aspects, as desired. Further, while the dynamic interest rate adjustment application 307, data aggregation module 309, qualifying driver calculation module 311, safe driver calculation module 313, and interest rate adjustment calculation module 315 are depicted as separate components of memory unit 306, two or more of these components may be integrated into different integrated applications and/or integrated modules. Moreover, one or more of the dynamic interest rate adjustment application 307, data aggregation module 309, qualifying driver calculation module 311, safe driver calculation module 313, and interest rate adjustment calculation module 315 may be implemented in conjunction with other application (not shown) that are stored and executed via the interest rate calculation engine 300 and/or other components in communication with the interest rate calculation engine 300.

In the present aspects, data aggregation module 309 is a portion of memory unit 306 configured to store instructions, that when executed by processing unit 302, cause processing unit 302 to perform various acts in accordance with applicable aspects as described herein. For example, instructions stored in data aggregation module 309 may facilitate processing unit 302 performing functions associated with collecting and aggregating data from various sources to generate a user profile. For example, data aggregation module 309 may include instructions to facilitate monitoring various data sources and/or receiving data from one or more data sources over time to build a user profile that may also change over time as new data is acquired.

Again, the data sources may include, for example, data received from one or more financial institutions (e.g., one or more financial institutions 150), one or more back-end computing devices (e.g., one or more back-end computing devices 120), one or more client devices (e.g., one or more client devices 102.1-102.3), one or more vehicles (e.g., one or more client vehicles 104.1-104.3), one or more smart infrastructure components (e.g., smart infrastructure component 106), etc. In various aspects, this data may represent user input (e.g., via one of client devices 102.1-102.3) and/or other types of data that mat be acquired with or without user input. For instance, a user may be solicited via a suitable computing device (e.g., via client device 200) in the form of survey questions, prompts, etc., for information that is then aggregated with other data included in the user's data profile. Some examples of data that may be acquired from a user or other devices that is used to generate a user profile may include, for example, user information, insurance product information, installment-based program information, and/or telematics data, as further discussed herein.

To provide an illustrative example with reference to FIG. 4, which shows an example of information associated with a user profile 400, data aggregation module 309 may facilitate processing unit 302 (e.g., via communication unit 304) aggregating various portions of any suitable, relevant data, to generate a user profile. This user profile may then be stored in any suitable portion of interest rate calculation engine 300 (e.g., memory unit 306) and/or another suitable storage device that is accessible by interest rate calculation engine 300 (e.g., one or more back-end components 120).

It will be understood that the examples shown in FIG. 4 associated with user profile 400 such as the user information, insurance product information, installment-based program information, and/or telematics data, etc., are but some examples of the types of information that may be relevant to identify qualifying drivers, determine whether qualifying drivers are safe enough to further qualify as safe drivers eligible for one or more interest rate adjustments, and to effectuate adjusting an interest rate accordingly for such a user. A user profile 400 may, therefore, include any suitable number and/or type of relevant information that is useful or otherwise relevant to do so.

For example, as shown in FIG. 4, user information may include any suitable type of information that may uniquely identify a vehicle operator, devices, and/or vehicles associated with the operator to facilitate the correlation of a particular operator to his insurance policy information, telematics data, and/or installment-based products the operator is currently enrolled. For instance, the operator's user information may include a user ID, a client device ID, driving scores, a vehicle ID, etc.

To provide additional examples, user profile 400 may include operator's insurance product information, which may represent any suitable type of data associated with a user's insurance coverage. For instance, insurance product information may include information regarding a particular operator's assessed risk for purposes of insuring that operator, and/or information that allows a particular operator's insurance products to be identified. Some examples of this information may include insurance policy numbers, current premiums, a current safety tier associated with the operator, etc. In various aspects, the insurance product information may be provided, in whole or in part, by an insurer that is insuring the operator associated with user profile 400.

To provide additional examples, user profile 400 may include installment-based program information, which may represent any suitable type of data associated with the various installment-programs that a user may be enrolled. Again, this may include, for example, deposit accounts, auto financing loans, mortgages, credit cards, home equity loans, etc. The installment-based program information may include the various details associated with such programs to enable the user's loan information to be correlated to other data in the user's profile, to determine whether the user qualifies for an adjusted interest rate, and to contact the appropriate parties to enact the adjustment. For example, as shown in FIG. 4, the installment-based program information may include current interest rates (i.e., before or after being adjusted), payment information (e.g., an amount per month, per week, etc., currently paid by the user in accordance with the terms of each installment-based program), an amortization schedule, etc.

Additionally or alternatively, the installment-based program information may include information about various partner providers. This may include, for example, various financial institutions that offer the installment-based programs and who have agreed to participate in a program by which the user's interest rate (or other parameters) may be adjusted based upon driving safety. In some aspects, this may include branches or subsidiaries of the insuring entity. But in other aspects, this may include other financial institutions who have contractually or otherwise agreed to adjust a user's interest rate (or other parameters) in accordance with an established set of conditions, logic, and/or rules, which are further discussed herein.

To provide yet additional examples, user profile 400 may include telematics data, which may represent any suitable type of data that is received in accordance with one or more telematics data transmissions, as discussed herein. In various aspects, the telematics data may include any suitable type of data that may be used to calculate a driving score and/or to otherwise assess driver safety, which may then be correlated to other data in the user's profile. Again, this may include various types of information that may be received, stored, and/or tracked over time. For instance, the telematics data stored in the user's profile may include geographic location data (e.g., of a user's associated client device), acceleration, cornering, and/or braking data, weather data, tracked velocity data, a client device ID, etc. Once a suitable amount of data has been stored in a user's profile, aspects include interest rate calculation engine 300 analyzing this data to identify one or more safe drivers who are eligible for an interest rate (or other parameter) adjustments. Furthermore, interest rate calculation engine 300 may perform the calculations to determine any relevant updated parameters and communicate this information to the appropriate financial institutions associated with the installment-based programs to effectuate these changes. The interest rate calculation engine 300 may additionally transmit one or more notifications to the user (i.e., the driver associated with that particular user profile), to provide information regarding any changes. These additional operations are discussed in further detail below.

In the present aspects, qualifying driver calculation module 311 is a portion of memory unit 306 configured to store instructions, that when executed by processing unit 302, cause processing unit 302 to perform various acts in accordance with applicable aspects as described herein. For example, instructions stored in qualifying driver calculation module 311 may facilitate processing unit 302 performing functions associated with calculating and/or receiving a driving score and identifying which drivers are eligible, and therefore qualify, for dynamic interest rate adjustment.

In some aspects, interest rate calculation engine 300 may calculate driving scores for one or more drivers based upon, for example, telematics data stored in each driver's user profile. But in other aspects, interest rate calculation engine 300 may receive driving scores that are calculated via another computing device (e.g., one of client devices 102.1-102.3 and/or one or more back-end components 120). In any event, certain aspects may include the driving scores being calculated in any suitable manner that considers driving performance, which may be based upon any suitable number of driving sessions over which telematics data was collected. For example, the driving score may correspond to any suitable combination, weighting, aggregation, etc., of various metrics indicated by the telematics data at any given point in time or averaged over several driving sessions.

For example, the driving score may be represented as a quantified scaled value, grading system, etc., that indicates driving safety for a particular driver. To provide an illustrative example, the driving score may be represented as a number between 0 and 100, with 0 representing the least safe type of driver, and 100 representing the safest type of driver. To facilitate such calculations, aspects include the driving score calculation being implemented by starting with the highest safety rating (i.e., 100 in this example), and being reduced over time upon the occurrence of various driving events, as indicated by the telematics data.

For example, acceleration, braking, and cornering data included in the telematics data may indicate when the driver accelerated too fast, hit the brakes too hard, turned too quickly, etc. Furthermore, velocity data included in the telematics data may indicate whether, when correlated to the geographic location data, the driver typically obeys posted speed limits. Moreover, aspects include establishing a weighted system that deducts more points from the initial score based upon the severity of each event. For example, driving events related to acceleration, cornering, and braking may be categorized based upon their severity using a graduating thresholding system, where increasing threshold values, when exceeded, indicate increasing event severity. To provide another example, driving events related to speeding may be further categorized by severity based upon how much faster than the posted speed limit the operator was driving the vehicle. These deductions may be calculated over any suitable time frame such that a driver's driving score accurately reflects her overall driving safety. For example, a new driving score may be calculated for each driving session, with the driving score representing a cumulative or rolling average of previous driving scores.

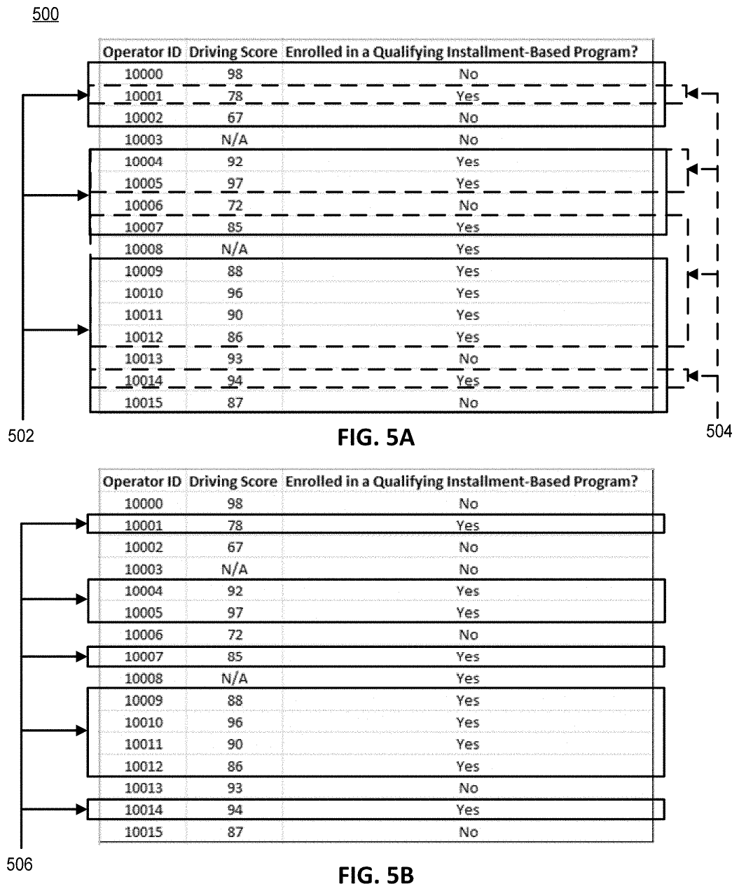

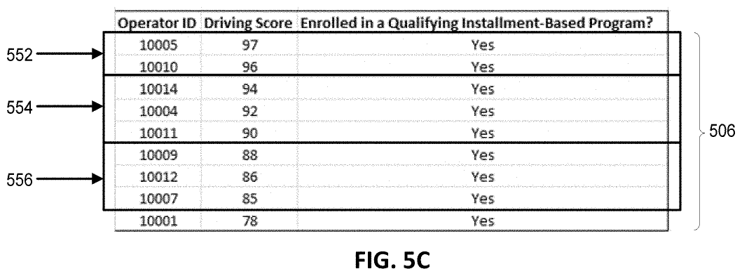

Aspects further include qualifying driver calculation module 311 facilitating the identification of qualifying drivers by accessing one or more user profiles associated with various drivers. This may include, for example, interest rate calculation engine 300 retrieving a list of various insured drivers in a particular region by accessing each respective driver's user profile from that region. To provide an illustrative example with reference to FIGS. 5A-5B, FIG. 5A illustrates an example of information 500 that is accessed from several user profiles, such as user profile 400, for example, as discussed herein. For ease of explanation, the information 500 is presented in FIGS. 5A-5B in a tabular format. However, it will be understood that interest rate calculation engine 300 may store data representing the same or similar information in any suitable format to facilitate the various analyses and calculations as described herein.

As shown in FIG. 5A, each driver is associated with a unique operator ID, which may represent any suitable unique information that allows each user to be identified, such as a device ID, login ID, etc. FIG. 5A also indicates a corresponding driving score for various drivers as well as an indication of whether each driver is participating in a qualifying installment-based program (i.e., one that qualifies for interest rate adjustment based upon driving safety). For some drivers, there is no driving score available. This could be the case, for example, when a driver is relatively new insured driver and there is not sufficient data available to calculate a driving score. This may also be the case, for example, when a driver has not opted in to the telematics data collection process, and therefore a driving score cannot be calculated.

In any event, aspects include instructions stored in qualifying driver calculation module 311 facilitating interest rate calculation engines 300 identifying which of the overall set of drivers potentially qualify for interest rate reductions. To do so, interest rate calculation engine 300 may initially identify operators for which a driving score is available, which are labeled in FIG. 5A as operators 502. Next, interest rate calculation engine 300 may identify operators that are enrolled in an installment-based program, which are labeled in FIG. 5A as operators 504. From these sets of operators 502 and 504, the interest rate calculation engine 300 may then identify qualifying operators 506 who are part of both the set of operators 502 and the set of operators 504. In other words, the qualifying operators are those that have an associated driving score available and are also participating in a qualifying installment-based product. Once a pool of potentially qualifying drivers has been identified, interest rate calculation engine 300 may then identify, from those that potentially qualify, safe drivers who actually do so, which is further discussed below.

In the present aspects, safe driver calculation module 313 is a portion of memory unit 306 configured to store instructions, that when executed by processing unit 302, cause processing unit 302 to perform various acts in accordance with applicable aspects as described herein. For example, instructions stored in safe driver calculation module 313 may facilitate processing unit 302 performing functions associated with identifying safe operators included in the set of qualifying operators.

To do so, certain aspects include safe driver calculation module 313 including instructions that define any suitable number and/or of conditions that, when satisfied, result in one of the qualifying operators 506 being identified as a “safe” driver by interest rate calculation engine 300. For ease of explanation, this determination is explained herein by exclusively relying upon each qualifying operator's driving score. However, it will be understood that other conditions, or a combination of other conditions in conjunction with each operator's driving score, may also be used to identify safe drivers from the pool of qualifying operators 506. For example, this determination may additionally or alternatively be made based upon any other suitable indicator of assessed driving risk such as driving history, a number of claims previously filed, etc.

For example, as shown in FIG. 5C, the set of qualifying operators 506 are presented in a separate set of information 550, in which each qualifying operator is ranked according to his driving score. In various aspects, one or more driving score thresholds may be established that, when exceeded by a qualifying operator, identifies that qualifying operator as a safe driver. In various aspects, any suitable number of threshold scores may be established, and may provide safe driver segments of any suitable level of granularity. In this way, each driving score threshold may establish a different level, or tier, of driving safety, allowing the interest rate for safe operators to be adjusted by an amount that is based upon each tier's respective exceeded threshold score, as further discussed below.

As shown in FIG. 5C, the qualifying operators 506 are further segmented into three tiers to define varying levels of driving safety. The first tier of safe operators 552 is associated with drivers having a driving score of 95 or higher, and are thus considered the safest drivers from among all the qualifying operators 506. The second tier of safe operators 554 is associated with drivers having a driving score less than 95, but greater than or equal to 90, and are thus considered safe drivers as well, albeit not as safe as the first tier of safe operators 552. The third tier of safe operators 556 is associated with drivers having a driving score less than 90, but greater than or equal to 85, and are thus also considered safe drivers, but not as safe as the first and second tiers of safe operators 552 and 554.

It should be noted that due to the particular threshold chosen for safe operators 556, not all of the qualifying operators 506 may be considered safe drivers for the purposes of being eligible for interest rate adjustments. For instance, the driver associated with operator ID 10001 has a driving score of 78, and thus will not be considered a safe driver. However, aspects further include interest rate calculation engine 300 periodically accessing data stored in one or more user profiles, which may be periodically updated as new information is received. For example, interest rate calculation engine 300 may periodically receive updated driving scores associated with the same set of vehicle operators or additional vehicle operators that may later opt-in to telematics data collection.

Continuing this example, interest rate calculation engine 300 may then repeat the steps discussed above to identify an updated set of qualifying operators and an updated set of safe operators. Moreover, and as further discussed below, interest rate calculation engine 300 may periodically adjust the interest rate associated with an installment-based program for each updated safe operator such that the interest rate for each of the identified safe operators is periodically updated as well. In this way, an additional incentive is provided for certain operators (e.g., the operator associated with operator ID 10001) to improve his driving safety to qualify for interest rate adjustments, while incentivizing safe vehicle operators to maintain their safe driving behavior as well to maintain these benefits.

In the present aspects, interest rate adjustment calculation module 315 is a portion of memory unit 306 configured to store instructions, that when executed by processing unit 302, cause processing unit 302 to perform various acts in accordance with applicable aspects as described herein. For example, instructions stored in interest rate adjustment calculation module 315 may facilitate processing unit 302 performing functions associated with the calculation of one or more parameters associated with an installment-based program to incentivize safer driving. In various aspects, these parameters may be related to any suitable portion of the installment-based programs that yield monetary savings for an operator who is identified as a safe driver.

For example, a driver may have a $20,000 vehicle loan for a term of 48 months at an interest rate of 2.9%. Although the amortization schedule for the vehicle loan defines the proportions of interest and principal that are allocated with each monthly installment payment, the driver still pays approximately $442 per month for the vehicle loan at this interest rate. Assume that this same driver, after paying 24 monthly payments, is identified as a safe driver and therefore qualifies for a reduction of 50 basis points to the original interest rate of 2.9%, resulting in a new interest rate of 2.4%. After 24 monthly payments have been made, the loan would have a balance of $9,872.70. In one aspect, the parameters of the vehicle loan may be adjusted such that the driver, upon qualifying for the new interest rate, now has a vehicle loan that is equivalent to a $9,872.70 vehicle loan for a term of 24-months at a rate of 2.4%. As a result, the new monthly payment is approximately $422, a monthly savings of $20 per month.

In various aspects, the amortization schedule may also be adjusted so as not to penalize the safe driver by “restarting” the amortization. For example, when the user pays the 24^{th} monthly payment in the example above, about $416 is allocated to paying down the principal, while $26 is allocated to paying the loan interest. In other words, at the time the driver qualified for the reduced interest rate, about 94% of the monthly payment was allocated to paying down the principal, with the remaining 6% allocated to paying off the loan interest. In one aspect, the parameters of the “new” $9,872.70 vehicle loan having a term of 24-months and an adjusted interest rate of 2.4% may be adjusted such that the next payment reflects this same proportionality between the loan principal and interest payments. In this way, a driver may benefit from safer driving by saving money on loan payments without negatively affecting other aspects of the overall loan, and may allow a safe driver to pay off loans faster than would otherwise be possible.

The above example is provided for ease of explanation, and it is understood that vehicle loans utilize a simple interest calculation that may not be used for other types of loans such as mortgages. However, certain aspects include instructions stored in interest rate adjustment calculation module 315 facilitating processing unit 302 calculating any suitable type of parameters (e.g., modification to the amortization schedule, reduced interest rates, reduced loan terms, adjusting the principal amount, etc.) to accommodate providing reduced installment payments to safe drivers in accordance with any suitable type of installment-based program.

In some aspects, the reduced monthly payment for a safe driver may be facilitated in the form of an actual adjustment to one or more loan parameters, which may be communicated to the appropriate lender, creditor, etc., as the case may be. These adjustments may, for example, result in the installment-based program provider adjusting the terms of the loan based upon updated information received from interest rate calculation engine 300. For example, an installment-based program provider may specify contractual terms for the loan that are agreed to by the driver, allowing the installment-based program provider to adjust the loan parameters in response to the user being a safe driver in an agreed-upon manner.

However, in other aspects, the reduced monthly payment for a safe driver may be facilitated by “virtually” adjusting one or more loan parameters, such as the interest rate, for example. In accordance with such aspects, this may be facilitated by a party (e.g., the insurer or installment-based program provider) subsidizing any difference that would otherwise result in a reduction to the installment-based program. Using the vehicle loan described above as an example, instead of actually reducing the interest rate from 2.9% to 2.4%, an insurer or installment-based program provider may reduce the monthly-installment payment by $20 and pay the remaining portion (or receive the remaining portion from the insurer, if a different entity) that the safe driver would otherwise be responsible for. In other words, the insurer or installment-based program provider may provide an ongoing discount to the monthly-installment payment, with each monthly-installment payment being adjusted based upon the user's level of driving safety and/or whether the user qualified as a safe driver for a particular preceding time period.

Regardless of how reduced payments for a safe driver may be calculated or implemented, aspects include interest rate adjustment calculation module 315 facilitating processing unit 302 periodically or continuously calculating adjusted loan parameters (e.g., interest rates) based upon how safe each user drives. In some aspects, these adjustments may be made based upon each user's respective driving score. For example, if a tiered system is not used, then aspects may include processing unit 302 identifying drivers having a score over a single threshold value as safe drivers who qualify for interest rate adjustments. To provide an illustrative example with reference to FIG. 5C, assume that a threshold driving score is 80. In this case, only the driver associated with operator ID 10001 would not qualify for adjusted interest rates.

In other aspects, these adjustments may be made based upon each driver's exceeded threshold score in accordance with a tiered system, for example. To provide an illustrative example with reference to FIG. 5C, safe operators 552, 554, and 556 are associated with varying levels of driving safety in accordance with the particular threshold driving score established for each tier of safe drivers. Thus, aspects include interest rate adjustment calculation module 315 facilitating processing unit 302 calculating adjusted loan parameters (e.g., interest rates) by an amount that is based upon each tier. For instance, the safest drivers (safe operators 552) may have their interest rates reduced more than the safe operators 554, which may in turn their interest rates reduced more than the safe operators 556.

In the examples discussed herein, the interest rate (or other parameters) associated with an installment-based program are described as being reduced for safer drivers. However, certain aspects may also include periodically adjusting interest rates (or other parameters) associated with an installment-based program up or down based upon an assessment of each individual driver's driving safety. To provide an illustrative example with reference to FIG. 5C, the driver associated with operator ID 10010 may qualify for a particular reduced interest rate when part of the safe operators 552, but then qualify for another, lesser reduction in the interest rate if a subsequent update to his driving score causes the driver to be identified with the less safe operators 554. In this way, each driver's interest rate (and/or other installment-based program parameters) may be dynamically adjusted over time based upon a level of driving safety exhibited by each driver.

With regards to adjusting the interest rate for each driver, aspects include adjusting the interest rate in any suitable manner that takes each driver's level of driving safety into consideration. For example, a maximum adjustment rate (i.e., reduction “cap”) may be established for a maximum level of driving safety that is associated with a number of basis points. To provide another example, each tier of safe drivers may have their interest rates reduced by a number of basis points that is proportional to or otherwise based upon that tier's exceeded threshold score. To provide an illustrative example with reference to FIG. 5C, the maximum number of basis points that a loan may be reduced may be 100, and is associated with safe operators 552. However, safe operators 554 and 556 may qualify for interest rate reductions of 75 and 50 basis points, respectively. To provide another example, certain aspects may include reducing the number of basis points by a number that is equal to, or based upon some other proportionality, of each identified safe driver's driving score (e.g., 97 basis points for the driver associated with operator ID 10005, and 85 basis points for operator ID 10007). It will be understood that any suitable proportionality and/or relationship may exist between each driver's driving score and the number of basis points by which their interest rates, installment payments, and/or other parameters associated with the installment-based program may be reduced.

In still other aspects, the interest rate adjustment may be performed in accordance with a separate financial risk assessment that is based upon each driver's level of safe driving (e.g., their driving score). In accordance with such aspects, interest rate calculation engine 300 may correlate safe operators (e.g., the tiers of safe operators as shown in FIG. 5C) to a respective financial risk tier that is based upon each tier's respective exceeded threshold score. To provide an illustrative example with reference to FIG. 5C, safe operators 552, 554, and 556 may be correlated to financial risk tiers that indicate levels of financial risk matching their levels of driving safety. For instance, safe operators 552 are the safest drivers and thus represent the lowest financial risk, safe operators 554 represent a somewhat higher financial risk, while safe operators 556 are an even higher financial risk. In accordance with such aspects, interest rate calculation engine 300 may calculate an adjusted interest rate, or communicate with various installment-based program providers that may do so, such that the financial risk may be considered and the interest rate may be adjusted based upon each safe operator's correlated financial risk tier. These aspects may be particularly useful, for example, when an existing financial risk assessment structure is already in place to accurately calculate various installment-based program parameters using financial risk information as opposed to driving safety information.

The various aspects described herein are generally provided in the context of adjusting various installment-based program parameters, such as interest rates, for existing loans. However, certain aspects may also include interest rate adjustment calculation module 315 (or other suitable components of interest rate calculation engine 300) identifying one or more users who may qualify for reduced interest rates for new loans based upon their level of driving safety. For example, with reference to FIG. 5A, the driver associated with operator ID 10000 has an extremely safe driving score of 98, although this driver is not enrolled in a qualifying installment-based program. Therefore, certain aspects may include interest rate calculation engine 300 identifying various qualifying installment-based programs for which this particular user may be interested or qualify. Continuing this example, interest rate calculation engine 300 may then transmit an appropriate notification to this user indicating the reduction in interest rate or other favorable parameters for which the user may qualify as a result of his safe driving. In this way, the aspects described herein not only incentivize driving safety for drivers who already have various loans, credit cards, etc., but actively incentivize safe driving in the form of new, favorable installment-based programs for drivers that do not have these loans already but may need them.

An Exemplary Computer-Implemented Method of Dynamically Adjusting Interest Rates

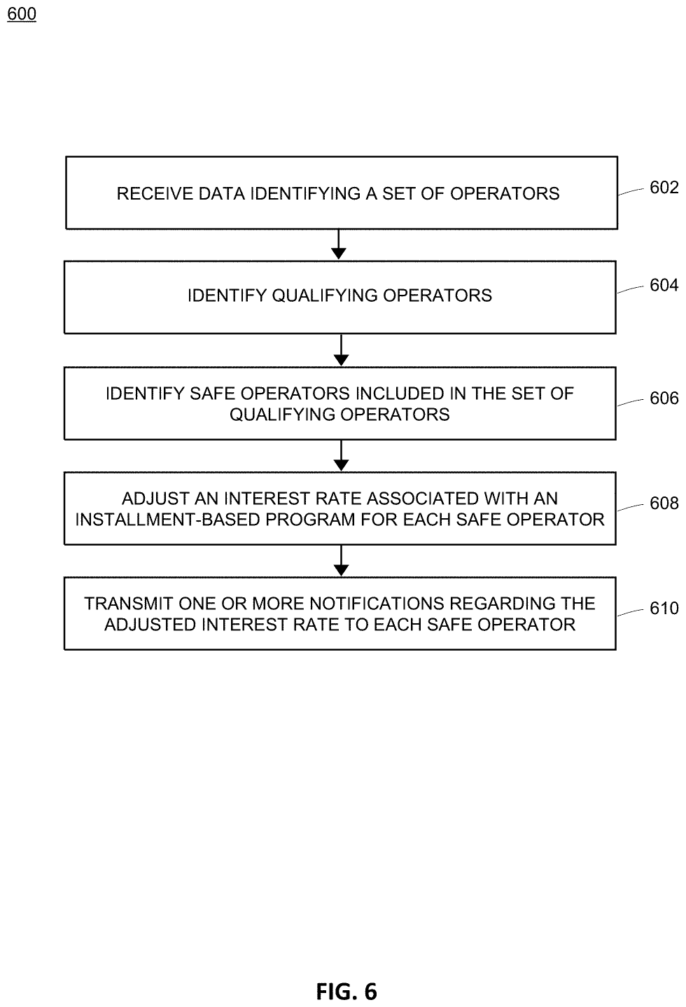

FIG. 6 illustrates a computer-implemented method flow 600, in accordance with certain aspects of the present disclosure. In the present aspects, one or more portions of method 600 (or the entire method 600) may be implemented by any suitable device, and one or more portions of method 600 may be performed by more than one suitable device in combination with one another. For example, one or more portions of method 600 may be performed by interest rate calculation engine 300, as shown in FIG. 3. In one aspect, method 600 may be performed by any suitable combination of one or more processors, instructions, applications, programs, algorithms, routines, etc. For example, method 600 may be performed via processing unit 302 executing instructions stored in memory unit 306, as shown in FIG. 3, in conjunction with data collected, received, and/or generated via one or more financial institutions (e.g., one or more financial institutions 150), one or more back-end computing devices (e.g., one or more back-end computing devices 120), one more smart infrastructure components (smart infrastructure components 106), and/or one or more client devices (e.g., client devices 102). Additionally or alternatively, method 600 may be performed via processing unit 302 executing instructions stored in memory unit 306, as shown in FIG. 3, in conjunction with data accessed, collected, and/or received from one or more user profiles, as discussed with reference to FIG. 4.

Method 600 may start when one or more processors receive data identifying a set of operators (block 602). This data may include, for example, data retrieved from one or more user profiles associated with individual insured drivers (block 602). For example, the data may include information identifying one or more users, their respective driving scores, and whether each user is enrolled in a qualifying installment-based program (block 602).

Method 600 may include one or more processors identifying qualifying operators from among the set of operators (block 604). This may include, for example, identifying operators for which a driving score is available and who are enrolled in an installment-based program, as discussed herein with reference to FIG. 5A, for example (block 604).

Method 600 may include one or more processors identifying safe operators included in the set of identified (block 604) qualifying operators (block 606). This may include, for example, identifying one or more qualifying operators having a driving score above a threshold value, which may be segmented into various tiers based upon defined thresholds (block 606). For example, the safe drivers may be segmented into various tiers to define varying levels of driving safety, such as the first tier of safe operators 552, the second tier of safe operators 554, and the third tier of safe operators 556, as discussed above with reference to FIG. 5C (block 606).

Method 600 may include one or more processors adjusting an interest rate associated with an installment-based program for each safe operator (block 608). This may include, for example, calculating a reduced interest rate and/or other various parameters associated with an installment-based program to provide each safe operator with a reduced installment payment (block 608). As discussed herein with reference to FIG. 3, this reduction may be proportional to, or otherwise based upon, each safe operator's individual driving score (block 608).

Method 600 may include one or more processors transmitting one or more notification regarding the adjusted interest rate to each identified safe operator (block 610). This may include, for example, transmitting a notification to a client device associated with the user indicating the details of the driving score, when the user qualified for a reduced interest rate, the new interest rate, the new payment amount, etc., which is then displayed via the client device (block 610).

### Technical Advantages

The aspects described herein may be implemented as part of one or more computer components such as a client device and/or one or more back-end components, such as interest rate calculation engine 120.1 and/or interest rate calculation engine 300, for example. Furthermore, the aspects described herein may be implemented as part of a computer network architecture that facilitates communications between various other devices and/or components. Thus, the aspects described herein address and solve issues of a technical nature that are necessarily rooted in computer technology.

For instance, aspects include analyzing various sources of data to generate a user profile and to calculate new installment-based program parameters in accordance with varying levels of driving safety. In doing so, the aspects overcome issues associated with the inconvenience of manual and/or unnecessary monitoring of such data by identifying drivers with the lowest driving risk (i.e., safe drivers), and correlating these drivers as likewise being a low financial risk. Without the improvements suggested herein, additional time, processing resources, and memory usage would be required to achieve these results.

Furthermore, the embodiments described herein function to analyze data sources over time, to update a user's profile based upon an aggregation of this data, and to dynamically update data stored in the user profile as well as installment-based program parameters. As a result, the process improves upon existing technologies by updating information in a more accurate manner to assess both driving and financial risk data in a manner that would otherwise be infeasible or impractical. The customization of installment-based parameters in combination with the recognition that safer drivers are fiscally more responsible improves upon the speed, efficiency, and accuracy in which such identifications and calculations could otherwise be performed. Due to these improvements, the aspects address computer-related issues regarding efficiency over the traditional amount of processing power and models used in underwriting and risk assessment procedures such as appropriately identifying risk, and determining how to properly incentivize insured drivers to decrease the risk of insuring them.

Thus, the aspects also improve upon computer technology by requiring fewer calculations due to the increased efficiency provided, for example, via the combination of processes, steps, elements, and/or components described herein. In other words, the specific combination of elements and/or components working in conjunction with one another (e.g., via networked communications) in and of itself represent a significant improvement to the overall technology involved. To be sure, the applications described herein produce a tangible improvement over conventional utilities which do not correlate overall driving safety to financial risk, and therefore fail to provide additional incentives for operators to continue or strive to drive safely, such as monetary incentives in the form of reduced interest rates and installment payments.

An Exemplary Computer-Implemented Method for Dynamically Adjusting Interest Rates Based Upon Driving Scores

In one aspect, a computer-implemented method for dynamically adjusting interest rates based upon driving scores may be provided. The method may include one or more processors (and/or associated transceivers) (1) receiving data identifying a set of operators; (2) identifying a set of qualifying operators (i) for which driving scores are available representing a quantified scaled value that indicates a level of driving safety for each respective operator from among the set of operators, and (ii) are enrolled in an installment-based program having an installment amount that is based upon an interest rate; (3) identifying safe operators included in the set of qualifying operators having a respective driving score exceeding a threshold score; and/or (4) adjusting the interest rate associated with the installment-based program for each safe operator included in the set of qualifying operators based upon the exceeded threshold score. The method may include additional, less, or alternate actions, including those discussed elsewhere herein

For instance, in various aspects, the installment-based program may include one or more of (i) deposit accounts, (ii) auto financing loans, (iii) mortgages, (iv) credit cards, and (v) home equity loans. Furthermore, the threshold score may be one of several in a set of threshold scores, each indicating a different respective level of driving safety. In such a case, safe operators may be identified, for example, by identifying tiers of safe operators based upon which of the set of threshold scores is exceeded by each respective operator included in the set of qualified operators

Additionally or alternatively, the interest rate associated with the installment-based program may be adjusted for safe operators included in the tiers of safe operators by an amount that is based upon each tier's respective exceeded threshold score.

Furthermore, the method may include correlating safe operators included in the tiers of safe operators to a financial risk tier that is based upon each segment's respective exceeded threshold score. In such an instance, the interest rate may then be adjusted based upon each safe operator's correlated financial risk tier.

Additionally, the method may include, periodically repeating the acts of (i) receiving updated data identifying an updated set of operators, (ii) identifying a set of updated qualifying operators from the updated set of operators, (iii) identifying updated safe operators having a respective driving score exceeding a threshold score, and (iv) adjusting the interest rate associated with the installment-based program for each of the updated safe operators.

Still further, aspects include adjusting the interest rate by reducing the interest rate a number of basis points that is proportional to the exceeded threshold score, such that the installment amount is temporarily reduced.

An Exemplary Computing Device for Dynamically Adjusting Interest Rates Based Upon Driving Scores

In yet another aspect, a computing device for dynamically adjusting interest rates based upon driving scores may be provided. The computing device may include (1) one or more communication units (and/or associated transceivers) configured to receive data identifying a set of operators. The computing device may further include (2) a processing unit configured to (a) identify a set of qualifying operators (i) for which driving scores are available representing a quantified scaled value that indicates a level of driving safety for each respective operator from among the set of operators, and (ii) are enrolled in an installment-based program having an installment amount that is based upon an interest rate, and (b) identify safe operators included in the set of qualifying operators having a respective driving score exceeding a threshold score; and (c) adjust the interest rate associated with the installment-based program for each safe operator included in the set of qualifying operators based upon the exceeded threshold score. The computing device may include additional, less, or alternate components, including those discussed elsewhere herein.

For instance, in various aspects, the installment-based program may include one or more of (i) deposit accounts, (ii) auto financing loans, (iii) mortgages, (iv) credit cards, and (v) home equity loans. Furthermore, the threshold score may be one of several in a set of threshold scores, each indicating a different respective level of driving safety. In such a case, the processing unit may be further configured to identify safe operators, for example, by identifying tiers of safe operators based upon which of the set of threshold scores is exceeded by each respective operator included in the set of qualified operators.

Additionally or alternatively, the processing unit may be further configured to adjust the interest rate associated with the installment-based program for safe operators by an amount that is based upon each tier's respective exceeded threshold score.

Furthermore, the processing unit may be further configured to correlate safe operators to a financial risk tier that is based upon each segment's respective exceeded threshold score. In such an instance, the interest rate may then be adjusted based upon each safe operator's correlated financial risk tier.

Additionally, the communication unit may be further configured to periodically receive updated data identifying an updated set of operators. In such a case, the processing unit may also be further configured to (i) periodically identify a set of updated qualifying operators from the updated set of operators, (ii) periodically identify updated safe operators having a respective driving score exceeding a threshold score, and (iii) periodically adjust the interest rate associated with the installment-based program for each of the updated safe operators.

Still further, certain aspects include the processing unit being further configured to adjust the interest rate by reducing the interest rate a number of basis points that is proportional to the exceeded threshold score, such that the installment amount is temporarily reduced.

Exemplary Non-Transitory Computer Readable Medium for Dynamically Adjusting Interest Rates Based Upon Driving Scores

Still further, a non-transitory computer readable medium may be provided having instructions stored thereon that, when executed by one or more processors, cause the one or more processors to: (1) receive data identifying a set of operators; (2) identify a set of qualifying operators (i) for which driving scores are available representing a quantified scaled value that indicates a level of driving safety for each respective operator from among the set of operators, and (ii) are enrolled in an installment-based program having an installment amount that is based upon an interest rate; (3) identify safe operators included in the set of qualifying operators having a respective driving score exceeding a threshold score; and/or (4) adjust the interest rate associated with the installment-based program for each safe operator included in the set of qualifying operators based upon the exceeded threshold score.

For instance, in various aspects, the installment-based program may include one or more of (i) deposit accounts, (ii) auto financing loans, (iii) mortgages, (iv) credit cards, and (v) home equity loans. Furthermore, the threshold score may be one of several in a set of threshold scores, each indicating a different respective level of driving safety. In such a case, the instructions may, when executed by the one or more processors, cause the one or more processors to identify safe operators, for example, by identifying tiers of safe operators based upon which of the set of threshold scores is exceeded by each respective operator included in the set of qualified operators.

Additionally or alternatively, the instructions may, when executed by the one or more processors, cause the one or more processors to adjust the interest rate associated with the installment-based program for safe operators by an amount that is based upon each tier's respective exceeded threshold score.

Furthermore, the instructions may, when executed by the one or more processors, cause the one or more processors to correlate safe operators to a financial risk tier that is based upon each segment's respective exceeded threshold score. In such an instance, the interest rate may then be adjusted based upon each safe operator's correlated financial risk tier.

Additionally, the instructions may, when executed by the one or more processors, cause the one or more processors to periodically receive updated data identifying an updated set of operators. In such a case, the instructions may, when executed by the one or more processors, cause the one or more processors to (i) periodically identify a set of updated qualifying operators from the updated set of operators, (ii) periodically identify updated safe operators having a respective driving score exceeding a threshold score, and (iii) periodically adjust the interest rate associated with the installment-based program for each of the updated safe operators.

Still further, aspects include the instructions, when executed by the one or more processors, causing the one or more processors to adjust the interest rate by reducing the interest rate a number of basis points that is proportional to the exceeded threshold score, such that the installment amount is temporarily reduced.

### ADDITIONAL CONSIDERATIONS

As discussed herein, data may be collected from various sources to generate, update, and/or modify a user profile to accurately identify safe drivers and drivers enrolled in various installment-based programs. As described herein, the collection of data may be performed after the user agrees to such data monitoring or otherwise provides their affirmative consent.

This detailed description is to be construed as exemplary only and does not describe every possible embodiment, as describing every possible embodiment would be impractical, if not impossible. One may be implement numerous alternate embodiments, using either current technology or technology developed after the filing date of this application.

Furthermore, although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some exemplary embodiments, the one or more processors or processor-implemented modules may be located in a single geographic location (e.g., within a vehicle, within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

The various systems and methods described herein are directed to an improvement to computer functionality, and improve the functioning of conventional computers, as described, for example, in the “Technical Advantages” Section and elsewhere herein.

1. A computer-implemented method comprising:
collecting, by a computing device, data identifying a set of operators;
analyzing, by the computing device, the data to determine a set of qualifying operators from the set of operators based upon: (i) driving scores that indicate levels of driving safety for the set of operators, and (ii) enrollment in an installment-based program by the set of operators, the installment-based program having an installment amount that is based upon an interest rate;
determining, by the computing device, a set of safe operators from the set of qualifying operators, each safe operator in the set of safe operators having a driving score that exceeds a threshold score;
adjusting, by the computing device, the interest rate associated with the installment-based program for each safe operator in the set of safe operators based upon the exceeded threshold score;
collecting telematics data associated with the set of safe operators by a plurality of sensors, the plurality of sensors including an X-axis accelerometer, a Y-axis accelerometer, and a Z-axis accelerometer to measure a three-dimensional accelerometer vector;
analyzing the collected telematics data to determine one or more driving events associated with each safe operator in the set of safe operators, the one or more driving events including an acceleration event determined based on the collected telematics data including the three-dimensional accelerometer vector;
updating, by the computing device, the driving score based at least in part upon the one or more driving events for each safe operator in the set of safe operators; and
re-adjusting, by the computing device, the interest rate associated with the installment-based program for each safe operator in the set of safe operators based upon a comparison of how much the updated driving score for each safe operator differs from the exceeded threshold score,
wherein the adjusting the interest rate associated with the installment-based program comprises adjusting the interest rate associated with the installment-based program by reducing the interest rate by a number of basis points that is proportional to the exceeded threshold score such that the installment amount is temporarily reduced.

2. The computer-implemented method of claim 1, wherein:
the threshold score is from among a set of threshold scores, each indicating a different level of driving safety; and
determining the set of safe operators comprises identifying tiers of safe operators based upon which of the set of threshold scores is exceeded by each qualifying operator in the set of qualifying operators.

3. The computer-implemented method of claim 2, wherein adjusting the interest rate associated with the installment-based program further comprises:
adjusting the interest rate for each safe operator in the tiers of safe operators by an amount based upon the exceeded threshold score of each respective tier.

4. The computer-implemented method of claim 2, further comprising:
correlating, by the computing device, each safe operator in the tiers of safe operators to a financial risk tier based upon the exceeded threshold score of each respective tier; and
wherein adjusting the interest rate associated with the installment-based program further comprises adjusting the interest rate for each safe operator in the tiers of safe operators based upon the correlated financial risk tier associated with each safe operator.

5. The computer-implemented method of claim 1, further comprising:
periodically repeat (i) collecting updated data identifying an updated set of operators, (ii) analyzing the updated data to determine an updated set of qualifying operators from the updated set of operators, (iii) determining an updated set of safe operators from the updated set of qualifying operators, and (iv) adjusting the interest rate associated with the installment-based program for each updated safe operator in the updated set of safe operators.

6. The computer-implemented method of claim 1, wherein the installment-based program includes at least one selected from a group consisting of: (i) deposit accounts, (ii) auto financing loans, (iii) mortgages, (iv) credit cards, and (v) home equity loans.

7. (canceled)

8. (canceled)

9. A computing device, comprising:
a processing unit configured to:
collect data identifying a set of operators;
analyze the data to determine a set of qualifying operators from the set of operators based upon: (i) driving scores that indicate levels of driving safety for the set of operators, and (ii) enrollment in an installment-based program by the set of operators, the installment-based program having an installment amount that is based upon an interest rate;
determine a set of safe operators from the set of qualifying operators, each safe operator in the set of safe operators having a driving score that exceeds a threshold score;
adjust the interest rate associated with the installment-based program for each safe operator in the set of safe operators based upon the exceeded threshold score;
receive telematics data associated with the set of safe operators collected by a plurality of sensors, the plurality of sensors including an X-axis accelerometer, a Y-axis accelerometer, and a Z-axis accelerometer to measure a three-dimensional accelerometer vector;
analyze the collected telematics data to determine one or more driving events associated with each safe operator in the set of safe operators, the one or more driving events including an acceleration event determined based on the collected telematics data including the three-dimensional accelerometer vector;
update the driving score based at least in part upon the one or more driving events for each safe operator in the set of safe operators; and
re-adjust the interest rate associated with the installment-based program for each safe operator in the set of safe operators based upon a comparison of how much the updated driving score for each safe operator differs from the exceeded threshold score,
wherein the processing unit is further configured to adjust the interest rate associated with the installment-based program by reducing the interest rate by a number of basis points that is proportional to the exceeded threshold score such that the installment amount is temporarily reduced.

10. The computing device of claim 9, wherein:
the threshold score is from among a set of threshold scores, each indicating a different level of driving safety; and
the processing unit is further configured to determine the set of safe operators by identifying tiers of safe operators based upon which of the set of threshold scores is exceeded by each qualifying operator in the set of qualifying operators.

11. The computing device of claim 10, wherein the processing unit is further configured to adjust the interest rate by adjusting the interest rate for each safe operator in the tiers of safe operators by an amount based upon the exceeded threshold score of each respective tier.

12. The computing device of claim 10, wherein the processing unit is further configured to:
correlate each safe operator in the tiers of safe operators to a financial risk tier based upon the exceeded threshold score of each respective tier; and
adjust the interest rate associated with the installment-based program by adjusting the interest rate for each safe operator in the tiers of safe operators based upon the correlated financial risk tier associated with each safe operator.

13. The computing device of claim 9, wherein the processing unit is further configured to:
periodically repeat (i) collecting updated data identifying an updated set of operators, (ii) analyzing the updated data to determine an updated set of qualifying operators from the updated set of operators, (iii) determining an updated set of safe operators from the updated set of qualifying operators, and (iv) adjusting the interest rate associated with the installment-based program for each updated safe operators in the updated set of safe operators.

14. The computing device of claim 9, wherein the installment-based program includes at least one selected from a group consisting of: (i) deposit accounts, (ii) auto financing loans, (iii) mortgages, (iv) credit cards, and (v) home equity loans.

15. (canceled)

16. A non-transitory computer readable medium having instructions stored thereon that, when executed by one or more processors, cause the one or more processors to:
collect data identifying a set of operators;
analyze the data to determine a set of qualifying operators from the set of operators based upon: (i) driving scores that indicate levels of driving safety for the set of operators, and (ii) enrollment in an installment-based program by the set of operators, the installment-based program having an installment amount that is based upon an interest rate;
determine a set of safe operators from the set of qualifying operators, each safe operator in the set of safe operators having a driving score that exceeds a threshold score;
adjust the interest rate associated with the installment-based program for each safe operator in the set of safe operators based upon the exceeded threshold score;
receive telematics data associated with the set of safe operators collected by a plurality of sensors, the plurality of sensors including an X-axis accelerometer, a Y-axis accelerometer, and a Z-axis accelerometer to measure a three-dimensional accelerometer vector;
analyze the collected telematics data to determine one or more driving events associated with each safe operator in the set of safe operators, the one or more driving events including an acceleration event determined based on the collected telematics data including the three-dimensional accelerometer vector;
updating the driving score based at least in part upon the one or more driving events for each safe operator in the set of safe operators; and
re-adjust the interest rate associated with the installment-based program for each safe operator in the set of safe operators based upon a comparison of how much the updated driving score for each safe operator differs from the threshold score,
wherein the instructions that, when executed by the one or more processors, further cause the one or more processors to adjust the interest rate by reducing the interest rate by a number of basis points that is proportional to the exceeded threshold score such that the installment amount is temporarily reduced.

17. The non-transitory computer readable medium of claim 16, wherein:
the threshold score is from among a set of threshold scores, each indicating a different level of driving safety; and
the instructions, when executed by the one or more processors, further cause the one or more processors to determine the set of safe operators by identifying tiers of safe operators based upon which of the set of threshold scores is exceeded by each qualifying operator in the set of qualifying operators.

18. The non-transitory computer readable medium of claim 17, further including instructions that, when executed by the one or more processors, cause the one or more processors to adjust the interest rate associated with the installment-based program by adjusting the interest rate for each safe operator in the tiers of safe operators by an amount based upon the exceeded threshold score of each respective tier.

19. The non-transitory computer readable medium of claim 17, further including instructions that, when executed by the one or more processors, cause the one or more processors to:
correlate each safe operator in the tiers of safe operators to a financial risk tier based upon the exceeded threshold score of each respective tier; and
adjust the interest rate associated with the installment-based program by adjusting the interest rate for each safe operator in the tiers of safe operators based upon the correlated financial risk tier associated with each safe operator.

20. The non-transitory computer readable medium of claim 16, further including instructions that, when executed by the one or more processors, cause the one or more processors to:
periodically repeat (i) collecting updated data identifying an updated set of operators, (ii) analyzing the updated data to determine an updated set of qualifying operators from the updated set of operators, (iii) determining an updated set of safe operators from the updated set of qualifying operators, and (iv) adjusting the interest rate associated with the installment-based program for each updated safe operator in the updated set of safe operators.

21. The non-transitory computer readable medium of claim 16, wherein:
the installment-based program includes at least one selected from a group consisting of (i) deposit accounts, (ii) auto financing loans, (iii) mortgages, (iv) credit cards, and (v) home equity loans.
